(19) United States
(12) Patent Application Publication
(10) Pub. No.: US 2014/0060256 A1
(43) Pub. Date: Mar. 6, 2014

(54) WRENCH DEVICE

(71) Applicant: Alex Yang, Taichung City (TW)

(72) Inventor: Alex Yang, Taichung City (TW)

(21) Appl. No.: 13/602,301

(22) Filed: Sep. 3, 2012

(51) Int. Cl. B25B 13/46

(52) U.S. Cl. 81/58.5

(57) ABSTRACT

A wrench device includes a handle having two pivoting holes opened, a clamp member having an enclosing portion and two extension portions, the enclosing portion enclosing a driving member, the two extension portions having a gap communicating with the enclosing portion and two openings, a pivoting rod being inserted into each corresponding opening and pivoting hole, the driving member having an adapting hole and a fastening groove, the enclosing portion engaged with the fastening groove. Under this arrangement, when the handle is rotated in one direction, the enclosing portion of the clamp member tightly clamps the driving member, so that the driving member is rotated by the rotation of the handle; when the handle is rotated in another direction, the driving member is not rotated by the enclosing portion of the handle.

### BACKGROUND OF THE INVENTION

1. Field of the Invention

The present invention relates to a device, and more particularly to a wrench device.

2. Description of Related Art

A conventional ratchet wrench comprising a wrench body, a driving set, a cover member and a controlling member, a hole opened at one end of the wrench body therethrough, a receiving space axially defined on an inside wall of the hole relative to the wrench body, the receiving space being corresponding to another end of the wrench body, a side entry opened on one side of the receiving space, an assembling groove axially defined at a bottom of the receiving space relative to the wrench body, the controlling member assembled into the assembling groove, a positioning groove axially defined at a bottom of the assembling groove relative to the wrench body, the driving set having a ratchet and a driving block, the ratchet assembled into the hole, a plurality of teeth defined around an outer periphery of the ratchet, the driving block assembled into the receiving space, two abutting faces respectively defined at two ends of the driving block, the two abutting faces both abutting against the bottom of the receiving space, two engaging parts defined on one side of the driving block, the two engaging parts being close to each other, the two engaging parts being both corresponding to the ratchet, the teeth of the ratchet selectively engaged with one of the two engaging parts, the cover member covering the hole and the side entry of the receiving space, a cover opening opened on the cover member, the cover opening being corresponding to the ratchet and being used to sleeve a top of the ratchet, the controlling member having a switching member, a first elastomer and a second elastomer, the switching member inserted into the assembling groove and being rotatable relative to the assembling groove, the switching member having two indentations defined thereon, the two indentations being close to each other, the positioning groove being selectively corresponding to one of the two indentations, the first elastomer assembled onto the positioning groove to selectively abut against one of the two indentations of the switching member, the second elastomer assembled on the switching member to abut against the driving block. Under this arrangement, when the ratchet is rotated relative to the wrench body in one direction, the teeth of the ratchet are engaged with one engaging part of the driving block; in contrast, when the ratchet is rotated relative to the wrench body in another direction, the teeth of the ratchet are disengaged with one engaging part of the driving block step by step.

However, the conventional ratchet wrench has a disadvantage as following.

Since the structure of the conventional ratchet wrench is quite complicated and the elements of the conventional ratchet wrench are so many, manufacturing the conventional ratchet wrench is time consuming and difficult.

The present invention has arisen to mitigate and/or obviate the disadvantages of the conventional.

### SUMMARY OF THE INVENTION

The main objective of the present invention is to provide a wrench device.

To achieve the objective, a wrench device comprises a handle, a clamp member and a driving member, the handle having two pivoting holes opened at one end thereof, the clamp member having an enclosing portion defined at one end thereof, the enclosing portion having an enclosing hole opened thereon, the enclosing hole enclosing the driving member, the clamp member having two extension portions extended at another end thereof, the two extension portions have a gap defined therebetween, the gap communicating with the enclosing hole, each extension portion having an opening defined thereon, the opening of each extension portion corresponding to each corresponding pivoting hole of the handle, a pivoting rod being inserted into each opening and each corresponding pivoting hole so as to assemble the clamp member to the handle, the driving member having an adapting hole opened at a center thereof, the driving member having a fastening groove defined around an outer periphery thereof, the enclosing portion of the clamp member engaged with the fastening groove of the driving member so that the driving member is assembled to the clamp member. Wherein, each opening is formed as elliptic; each opening is opened inclinedly relative to the handle; the two openings are symmetrical with each other; each opening has a top end and a bottom end; the top end of each opening is adjacent to the enclosing portion; a distance between the top ends of the two openings is shorter than another distance between the bottom ends of the two openings; the enclosing hole has a plurality of engaging teeth defined around an inner periphery thereof; the fastening groove has a plurality of fastening teeth defined thereon; the enclosing portion is formed as two separated pieces; each separated piece of the enclosing portion has a connecting hole opened at one end thereof; a connecting pin is inserted into each connecting hole of the enclosing portion; a torsion spring encloses the connecting pin; one end of the torsion spring is abutted against an inner wall of one connecting hole and another end of the torsion spring is abutted against another inner wall of another connecting hole; the clamp member is flexible; the handle has two clipping portions defined at one end thereof; one clipping portion is above another clipping portion; the two pivoting holes are both opened from one clipping portion to another clipping portion therethrough; the two clipping portions clips a middle portion of each clamp member; each pivoting rod is inserted into the pivoting hole of each clipping portion and the opening of each corresponding extension portion; one end of the handle is tilted relative to the whole handle; when the user operates the handle, the handle will not abut against one of the two extension portions so that the rotation of the handle will not be limited by the extension portions. Under this arrangement, when a user wants to lock or unlock the screw, one extension portion is pushed toward one corresponding side of the handle firstly; and then, the handle is rotated in one direction; thereby, one pivoting rod moves to abut against one end of the corresponding opening, and another pivoting rod moves to abut against another end of another opening; as a result, one pivoting rod pushes one corresponding extension portion toward another extension portion, so that the gap is reduced. Therefore, the enclosing portion of the clamp member tightly clamps the fastening groove of the driving member in the enclosing hole, so that the driving member is rotated by the rotation of the handle via the clamp member. In contrast, when the handle does not be pushed toward one of the two extension portions, the gap is recovered. Therefore, the enclosing portion of the clamp member does not clamp the fastening groove of the driving member in the enclosing hole; as a result, the user rotates the handle in another direction, and the driving member is not rotated by the enclosing portion of the handle.

A wrench device comprising a handle, a clamp member and a driving member, the handle having two pivoting holes opened at one end thereof, the clamp member having an enclosing portion defined at one end thereof, the enclosing portion having an enclosing hole opened thereon, the enclosing hole enclosing the driving member, the clamp member having two extension portions extended at another end thereof, the two extension portions have a gap defined therebetween, the gap communicating with the enclosing hole, each extension portion having an opening defined thereon, the opening of each extension portion corresponding to each corresponding pivoting hole of the handle, a pivoting rod being inserted into each opening and each corresponding pivoting hole so as to assemble the clamp member to the handle, the driving member having an adapting hole opened at a center thereof, the driving member having a fastening groove defined around an outer periphery thereof, the enclosing portion of the clamp member engaged with the fastening groove of the driving member so that the driving member is assembled to the clamp member, the fastening groove having two sliding grooves defined on an inner wall thereof, the two sliding grooves respectively located at two sides of the gap, one end of each sliding groove adjacent to the gap, a depth of each sliding groove gradually decreased from one end thereof to another end thereof, each sliding groove having a rolling unit movably assembled therein; wherein when one rolling unit moves to another end of one sliding groove, a contacting area between the driving member and the rolling unit is increased, so that said rolling unit is tightly abutted against the driving member; as a result, the driving member is tightly fastened by the enclosing portion and said rolling unit. Wherein, each opening is formed as elliptic; each opening is opened inclinedly relative to the handle; the two openings are symmetrical with each other; each opening has a top end and a bottom end; the top end of each opening is adjacent to the enclosing portion; a distance between the top ends of the two openings is shorter than another distance between the bottom ends of the two openings; the handle has two clipping portions defined at one end thereof; one clipping portion is above another clipping portion; the two pivoting holes are both opened from one clipping portion to another clipping portion therethrough; the two clipping portions clips a middle portion of each clamp member; each pivoting rod is inserted into the pivoting hole of each clipping portion and the opening of each corresponding extension portion; the enclosing portion is formed as two separated pieces; each separated piece of the enclosing portion has a connecting hole opened at one end thereof; a connecting pin is inserted into each connecting hole of the enclosing portion; a torsion spring encloses the connecting pin; one end of the torsion spring is abutted against an inner wall of one connecting hole and another end of the torsion spring is abutted against another inner wall of another connecting hole; the clamp member is flexible; one end of the handle is tilted relative to the whole handle; when the user operates the handle, the handle will not abut against one of the two extension portions so that the rotation of the handle will not be limited by the extension portions. Under this arrangement, when a user wants to lock or unlock the screw, one extension portion is pushed toward one corresponding side of the handle firstly; and then, the handle is rotated in one direction; thereby, one pivoting rod moves to abut against one end of the corresponding opening, and another pivoting rod moves to abut against another end of another opening; as a result, one pivoting rod pushes one corresponding extension portion toward another extension portion, so that the gap is reduced; therefore, the enclosing portion of the clamp member tightly clamps the fastening groove of the driving member in the enclosing hole, so that the driving member is rotated by the rotation of the handle via the clamp member; in contrast, when the handle does not be pushed toward one of the two extension portions, the gap is recovered; as a result, the enclosing portion of the clamp member does not clamp the fastening groove of the driving member in the enclosing hole; therefore, the user rotates the handle in another direction, and the driving member is not rotated by the enclosing portion of the handle.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a main type of a first embodiment of a wrench device of the present invention;

FIG. 2 is a perspective view of the main type of the first embodiment of the wrench device;

FIG. 3 is a top view of the main type of the first embodiment of the wrench device;

FIG. 4 is a top view of the main type of the first embodiment for showing the wrench device being rotated in one direction;

FIG. 5 is a side view of the main type of the first embodiment of the wrench device;

FIG. 6 is an exploded view of a second embodiment of the wrench device of the present invention;

FIG. 7 is an exploded view of a clamp member of a main type of a third embodiment of the wrench device;

FIG. 8 is an exploded view of one sub type of the first embodiment of the wrench device;

FIG. 9 is a perspective view of one sub type of the first embodiment of the wrench device;

FIG. 10 is a top view of one sub type of the first embodiment of the wrench device;

FIG. 11 is a top view of one sub type of the first embodiment for showing the wrench device being rotated in one direction; and

FIG. 12 is an exploded view of the clamp member of one sub type of the third embodiment of the wrench device.

### DETAILED DESCRIPTION OF THE INVENTION

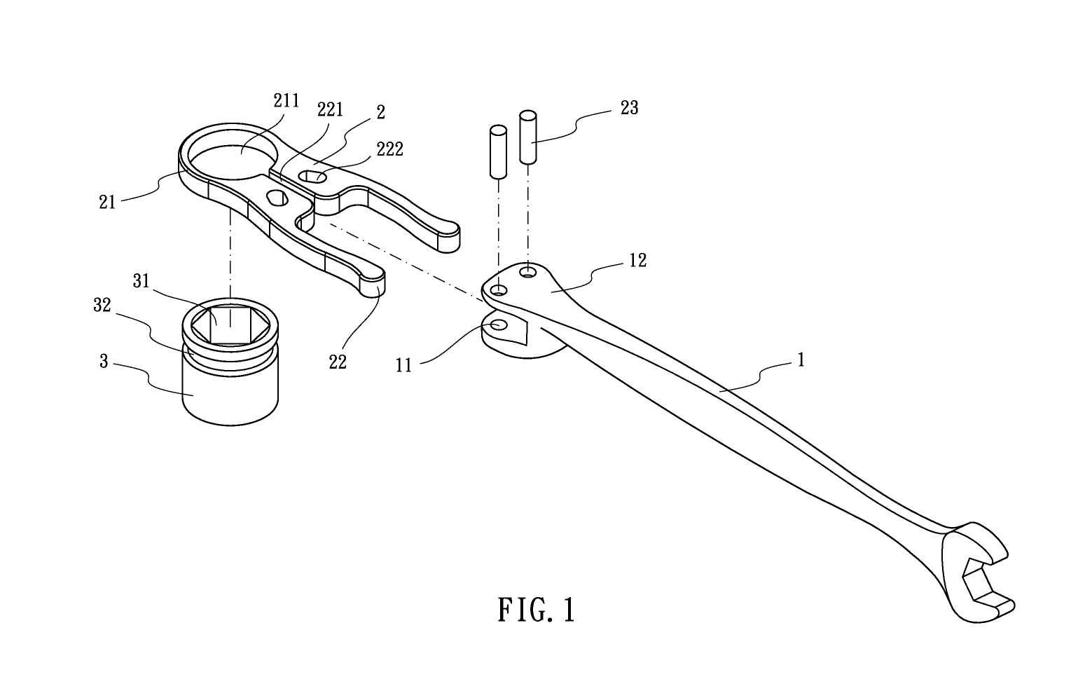

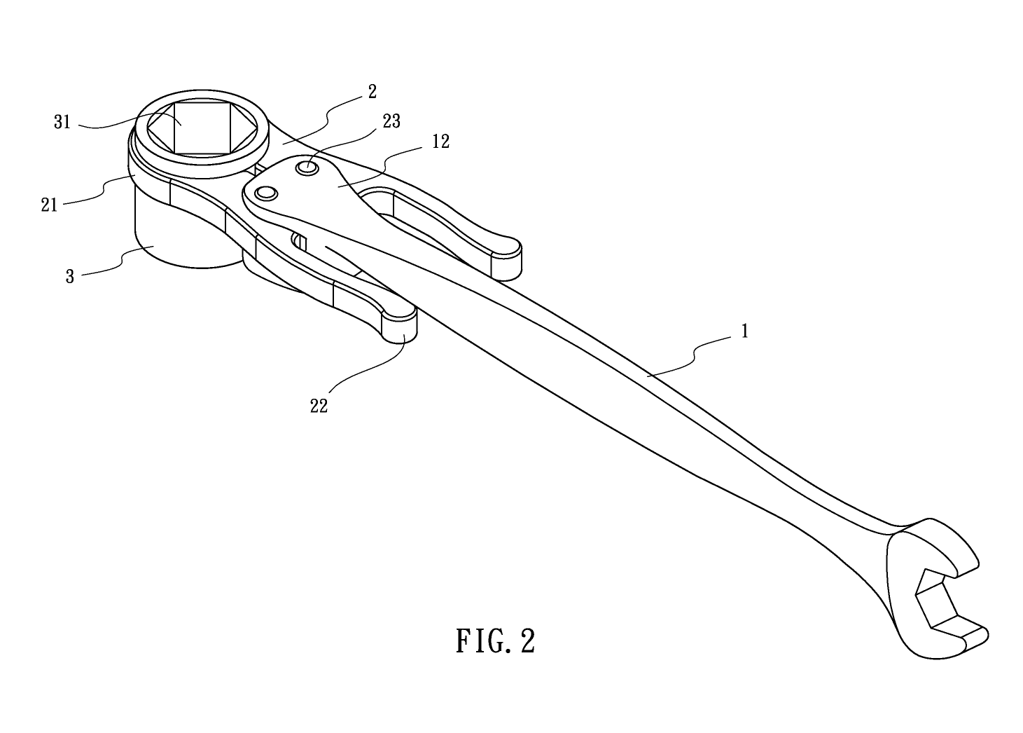

Referring to FIGS. 1-2, a main type of a first embodiment of a wrench device in accordance with the present invention comprises a handle 1, a clamp member 2 and a driving member 3.

The handle 1 has two pivoting holes 11 opened at one end thereof. The clamp member 2 has an enclosing portion 21 defined at one end thereof. The enclosing portion 21 has an enclosing hole 211 opened thereon. The enclosing hole 211 encloses the driving member 3. The clamp member 2 has two extension portions 22 extended at another end thereof. The two extension portions 22 have a gap 221 defined therebetween. The gap 221 communicates with the enclosing hole 211. Each extension portion 22 has an opening 222 defined thereon. The opening 222 of each extension portion 22 corresponds to each corresponding pivoting hole 11 of the handle 1. A pivoting rod 23 is inserted into each opening 222 and each corresponding pivoting hole 11 so as to assemble the clamp member 2 to the handle 1. The handle 1 has two clipping portions 12 defined at one end thereof. One clipping portion 12 is above (below) another clipping portion 12. The two pivoting holes 11 are both opened from one clipping portion 12 to another clipping portion 12 therethrough. The two clipping portions 12 clips a middle portion of each clamp member 2; thereafter, each pivoting rod 23 is inserted into the corresponding pivoting hole 11 of each clipping portion 12 and the opening 222 of each corresponding extension portion 22. Each opening 222 is formed as elliptic. Each opening 222 is opened inclinedly relative to the handle 1. The two openings 222 are symmetrical with each other. Each opening 222 has a top end and a bottom end. The top end of each opening 222 is adjacent to the enclosing portion 21. A distance between the top ends of the two openings 222 is shorter than another distance between the bottom ends of the two openings 222 (as shown in FIG. 1). The two extension portions 22 could be pushed toward each other by the pivoting rods 23 so that the gap 221 is reducible (the reduction of the gap 221 is limited by the relationship between the openings 222 and the pivoting rods 23). Therefore, the enclosing portion 21 is fastened inwardly.

The driving member 3 has an adapting hole 31 opened at a center thereof (In the present invention, the driving member 3 is formed as a sleeve as shown FIGS. 1-2). The driving member 3 has a fastening groove 32 defined around an outer periphery thereof. As shown in FIGS. 1-2, the enclosing portion 21 of the clamp member 2 is engaged with the fastening groove 32 of the driving member 3 so that the driving member 3 is assembled to the clamp member 2; as a result, a tool bit (not shown) is assembled into the adapting hole 31 of the driving member 3, so that the tool bit could be driven by the driving member 3 to lock or unlock a screw (not shown).

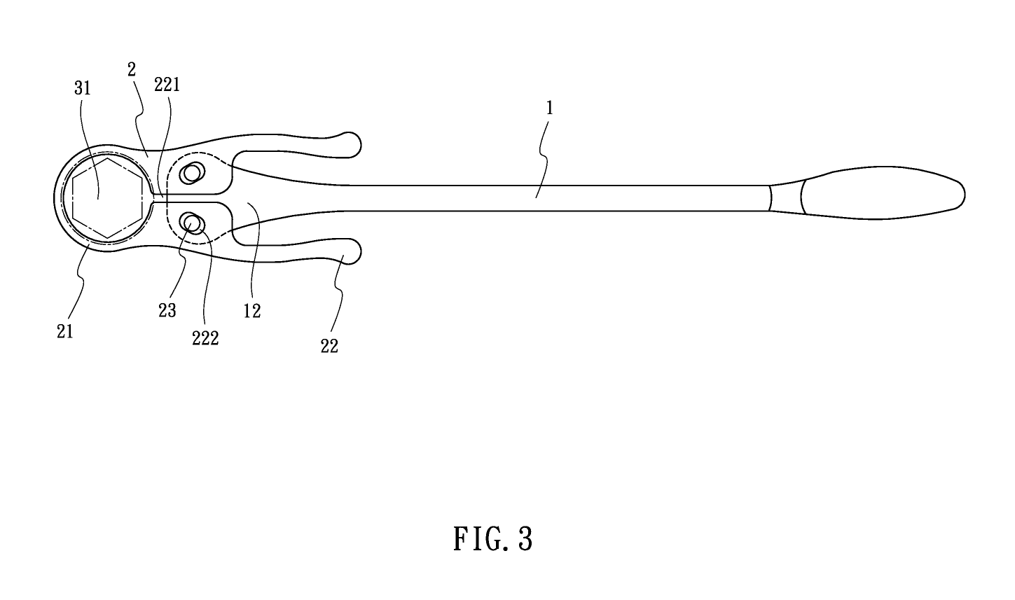

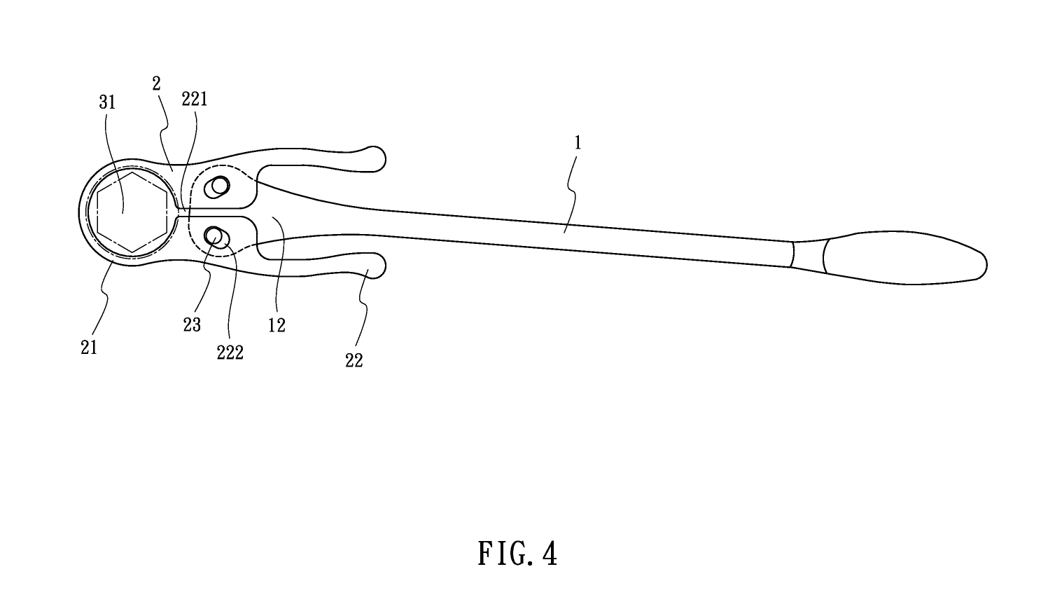

Under this arrangement, as shown in FIG. 4, when a user wants to lock or unlock the screw, one extension portion 22 is pushed toward one corresponding side of the handle 1 firstly; and then, the handle 1 is rotated in one direction; thereby, one pivoting rod 23 moves to abut against the top end of the corresponding opening 222, and another pivoting rod 23 moves to abut against the bottom end of another opening 222; as a result, one pivoting rod 23 pushes one corresponding extension portion 22 toward another extension portion 22 via a lever principle, so that the gap 221 is reduced. Therefore, the enclosing portion 21 of the clamp member 2 tightly clamps the fastening groove 32 of the driving member 3 in the enclosing hole 211, so that the driving member 3 is rotated by the rotation of the handle 1 via the clamp member 2. In contrast, as shown in FIG. 3, when the handle 1 does not be pushed toward one of the two extension portions 22, the gap 221 is recovered. Therefore, the enclosing portion 21 of the clamp member 2 does not clamp the fastening groove 32 of the driving member 3 in the enclosing hole 211; as a result, the user rotates the handle 1 in another direction, and the driving member 3 is not rotated by the enclosing portion 21 of the handle 1.

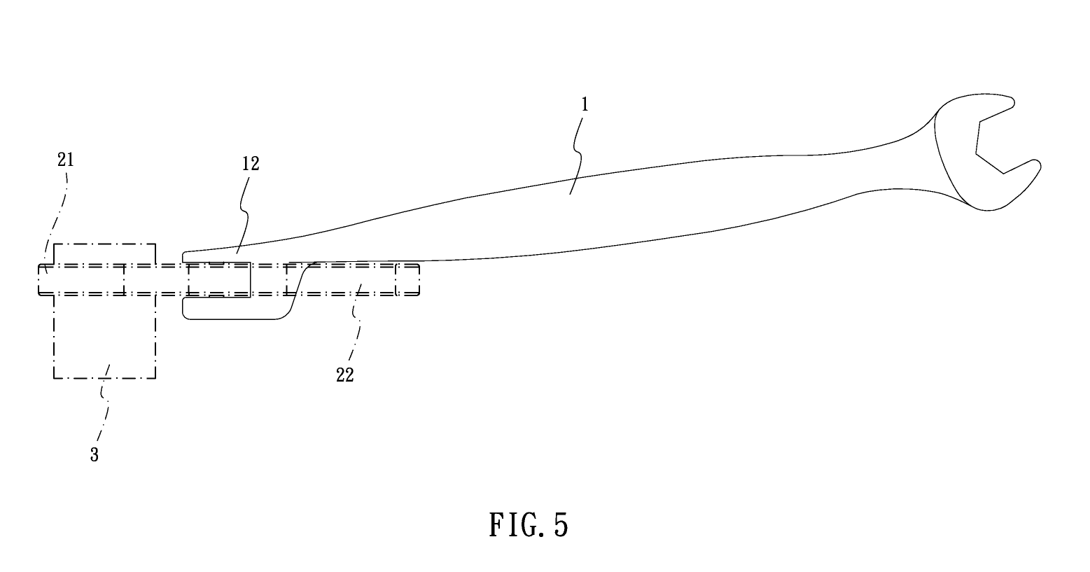

Moreover, as shown in FIG. 5, one end of the handle 1 is tilted relative to the whole handle 1. Under this arrangement, when the user operates the handle 1 to lock or unlock the screw, the handle 1 will not abut against one of the two extension portions 22 so that the rotation of the handle 1 will not be limited by the extension portions 22.

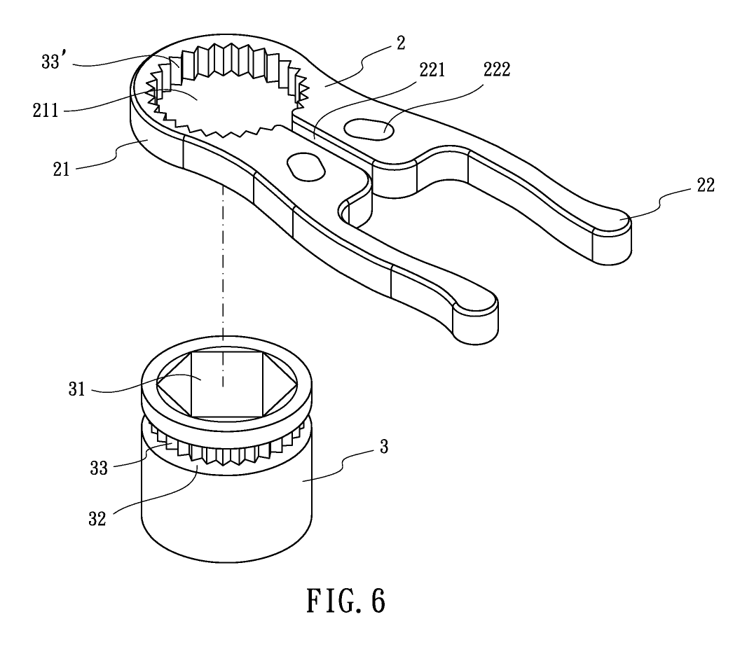

FIG. 6 shows a second embodiment of the wrench device in accordance with the present invention. (Only the differences between the first embodiment and the second embodiment are further described). The enclosing hole 211 has a plurality of engaging teeth 33′ defined around an inner periphery thereof. The fastening groove 32 has a plurality of fastening teeth 33 defined thereon. Therefore, when the driving member 3 is rotated by the rotation of the handle 1, the engaging teeth 33′ of the enclosing hole 211 are engaged with the fastening teeth 33 of the fastening groove 32; when the driving member 3 is not rotated by the rotation of the handle 1, the engaging teeth 33′ of the enclosing hole 211 are disengaged from the fastening teeth 33 of the fastening groove 32 step by step.

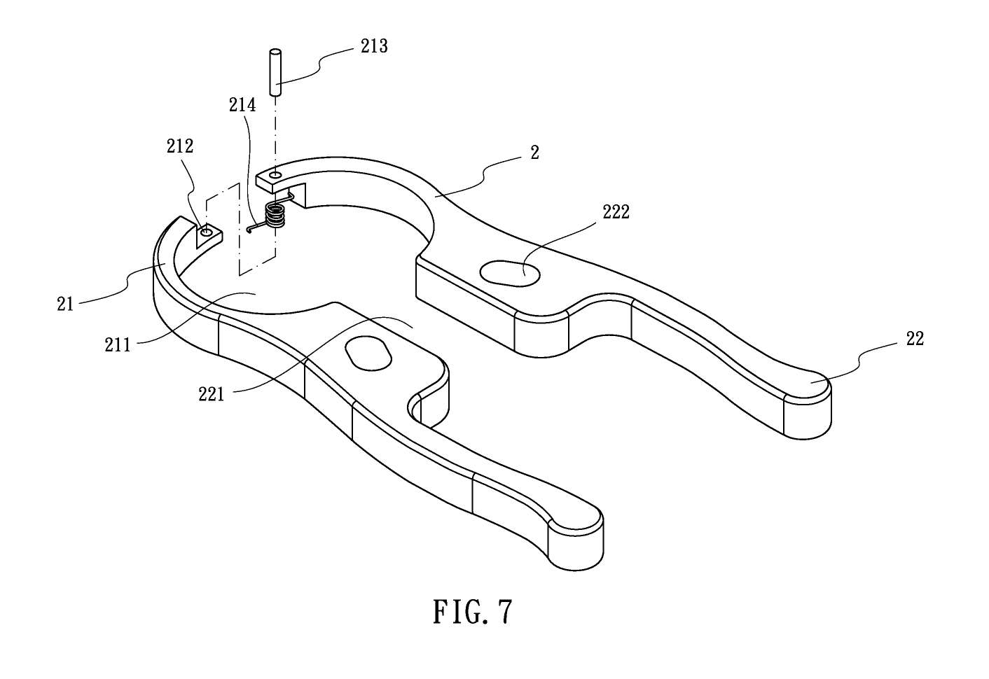

FIG. 7 shows a main type of a third embodiment of the wrench device in accordance with the present invention. (Only the differences between the first embodiment and the third embodiment are further described). The enclosing portion 21 is formed as two separated pieces. Each separated piece of the enclosing portion 21 has a connecting hole 212 opened at one end thereof. A connecting pin 213 is inserted into each connecting hole 212 of the enclosing portion 21. A torsion spring 214 encloses the connecting pin 213. One end of the torsion spring 214 is abutted against an inner wall of one connecting hole 212 and another end of the torsion spring 214 is abutted against another inner wall of another connecting hole 212. Therefore, the clamp member 2 is flexible.

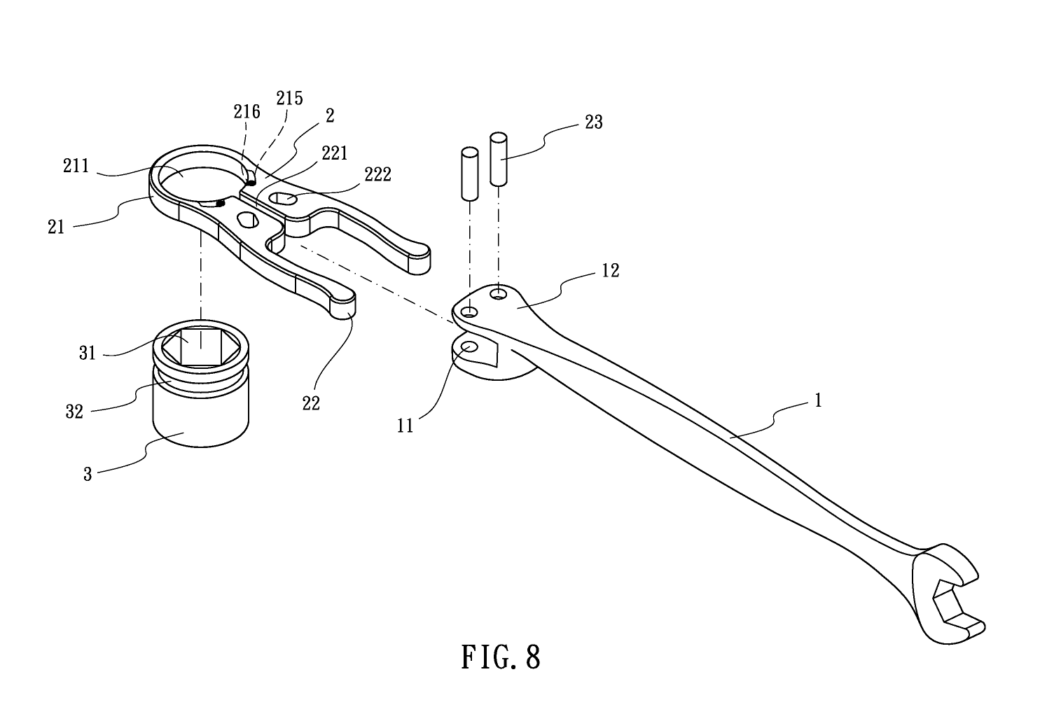

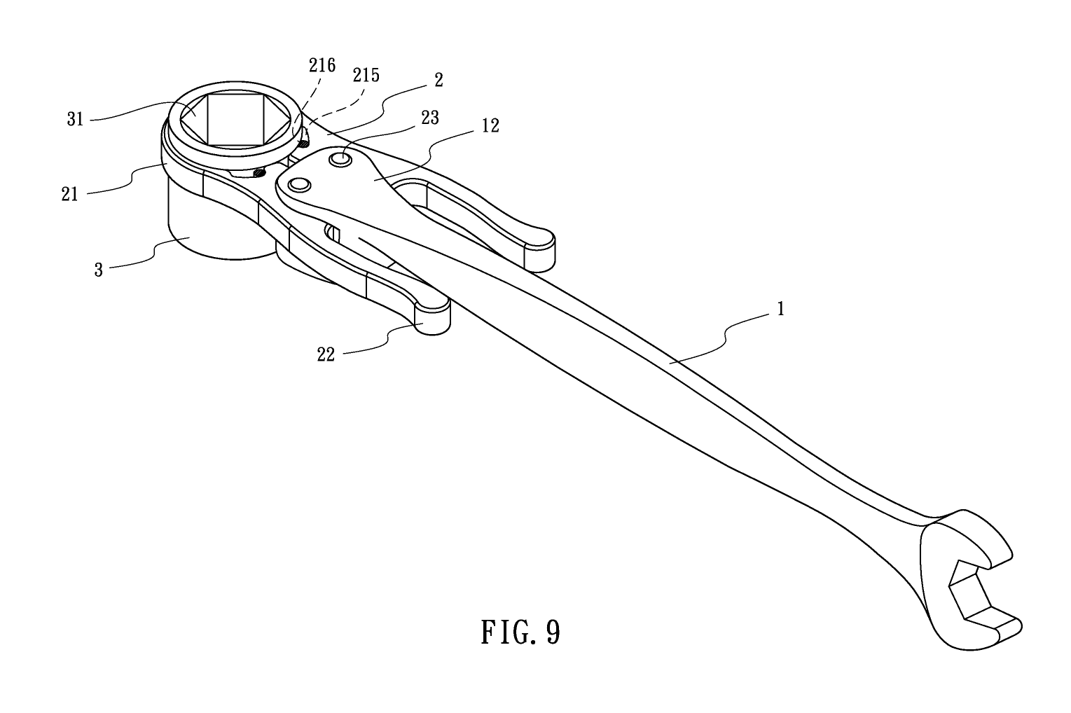

Referring to FIGS. 8-11, one sub type of the first embodiment of the wrench device in accordance with the present invention comprises a handle 1, a clamp member 2 and a driving member 3.

The handle 1 has two pivoting holes 11 opened at one end thereof. The clamp member 2 has an enclosing portion 21 defined at one end thereof. The enclosing portion 21 has an enclosing hole 211 opened thereon. The enclosing hole 211 encloses the driving member 3. The clamp member 2 has two extension portions 22 extended at another end thereof. The two extension portions 22 have a gap 221 defined therebetween. The gap 221 communicates with the enclosing hole 211. Each extension portion 22 has an opening 222 defined thereon. The opening 222 of each extension portion 22 corresponds to each corresponding pivoting hole 11 of the handle 1. A pivoting rod 23 is inserted into each opening 222 and each corresponding pivoting hole 11 so as to assemble the clamp member 2 to the handle 1.

The handle 1 has two clipping portions 12 defined at one end thereof. One clipping portion 12 is above (below) another clipping portion 12. The two pivoting holes 11 are both opened from one clipping portion 12 to another clipping portion 12 therethrough. The two clipping portions 12 clips a middle portion of each clamp member 2; thereafter, each pivoting rod 23 is inserted into the corresponding pivoting hole 11 of each clipping portion 12 and the opening 222 of each corresponding extension portion 22. Each opening 222 is formed as elliptic. Each opening 222 is opened inclinedly relative to the handle 1. The two openings 222 are symmetrical with each other. Each opening 222 has a top end and a bottom end. The top end of each opening 222 is adjacent to the enclosing portion 21. A distance between the top ends of the two openings 222 is shorter than another distance between the bottom ends of the two openings 222 (as shown in FIG. 8). The two extension portions 22 could be pushed toward each other by the pivoting rods 23 so that the gap 221 is reducible (the reduction of the gap 221 is limited by the relationship between the openings 222 and the pivoting rods 23). Therefore, the enclosing portion 21 is fastened inwardly.

The driving member 3 has an adapting hole 31 opened at a center thereof (In the present invention, the driving member 3 is formed as a sleeve as shown FIGS. 1-2). The driving member 3 has a fastening groove 32 defined around an outer periphery thereof. As shown in FIGS. 1-2, the enclosing portion 21 of the clamp member 2 is engaged with the fastening groove 32 of the driving member 3 so that the driving member 3 is assembled to the clamp member 2; as a result, a tool bit (not shown) is assembled into the adapting hole 31 of the driving member 3, so that the tool bit could be driven by the driving member 3 to lock or unlock a screw (not shown).

The enclosing hole 211 has two sliding grooves 215 defined on an inner wall thereof. The two sliding grooves 215 are respectively located at two sides of the gap 221. One end of each sliding groove 215 is adjacent to the gap 221. A depth of each sliding groove 215 is gradually decreased from one end thereof to another end thereof. Each sliding groove has a rolling unit 216 movably assembled therein. When one rolling unit 216 moves to another end of one sliding groove 215, a contacting area between the driving member 3 and the rolling unit 216 is increased, so that said rolling unit 216 is tightly abutted against the driving member 3; as a result, the driving member 3 is tightly fastened by the enclosing portion 21 and said rolling unit 216.

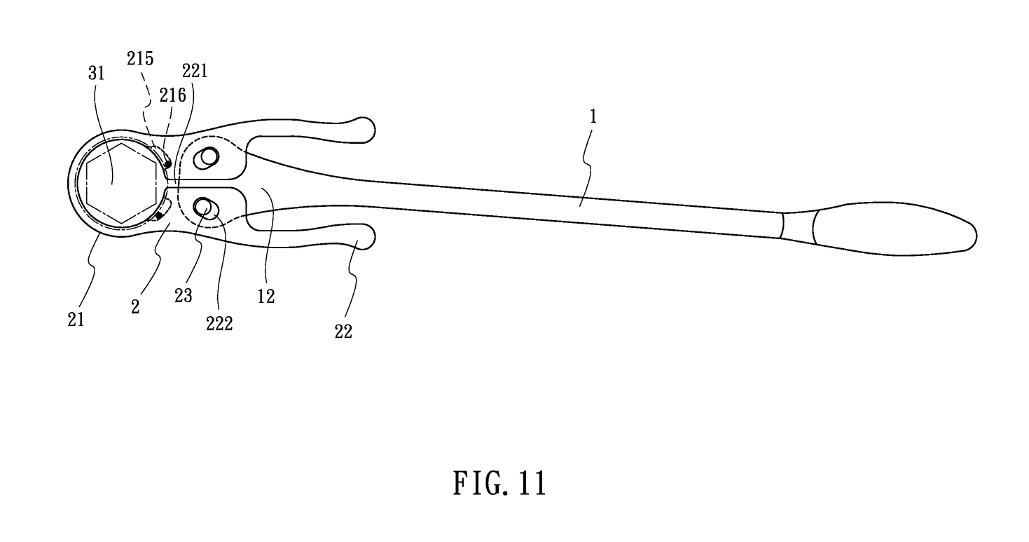

Under this arrangement, as shown in FIG. 11, when a user wants to lock or unlock the screw, one extension portion 22 is pushed toward one corresponding side of the handle 1 firstly; and then, the handle 1 is rotated in one direction; thereby, one pivoting rod 23 moves to abut against the top end of the corresponding opening 222, and another pivoting rod 23 moves to abut against the bottom end of another opening 222; as a result, one pivoting rod 23 pushes one corresponding extension portion 22 toward another extension portion 22 via a lever principle, so that the gap 221 is reduced. Therefore, the enclosing portion 21 of the clamp member 2 tightly clamps the fastening groove 32 of the driving member 3 in the enclosing hole 211, so that the driving member 3 is rotated by the rotation of the handle 1 via the clamp member 2.

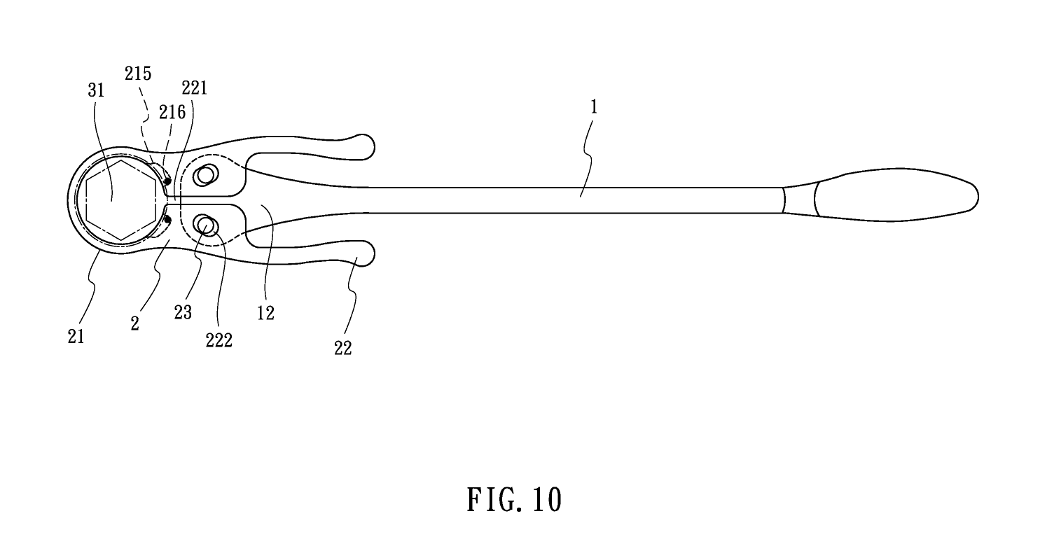

In addition, when the handle 1 is rotated in one direction, one rolling unit 216 moves to another end of the corresponding sliding groove 215 to tightly abut against the driving member 3 harder; meanwhile, another rolling unit 216 moves to one end of another sliding groove 215 to slightly touch the driving member 3. Therefore, because the driving member 3 is tightly fastened by the enclosing portion 21 and one rolling unit 216, the driving member 3 is rotated by the rotation of the handle 1 so as to lock or unlock the screw (not shown). In contrast, as shown in FIG. 10, when the handle 1 does not be pushed toward one of the two extension portions 22, the gap 221 is recovered. Therefore, the enclosing portion 21 of the clamp member 2 does not clamp the fastening groove 32 of the driving member 3 in the enclosing hole 211; as a result, the user rotates the handle 1 in another direction, and the driving member 3 is not rotated by the enclosing portion 21 of the handle 1.

Moreover, one end of the handle 1 is tilted relative to the whole handle 1. Under this arrangement, when the user operates the handle I to lock or unlock the screw, the handle 1 will not abut against one of the two extension portions 22 so that the rotation of the handle 1 will not be limited by the extension portions 22.

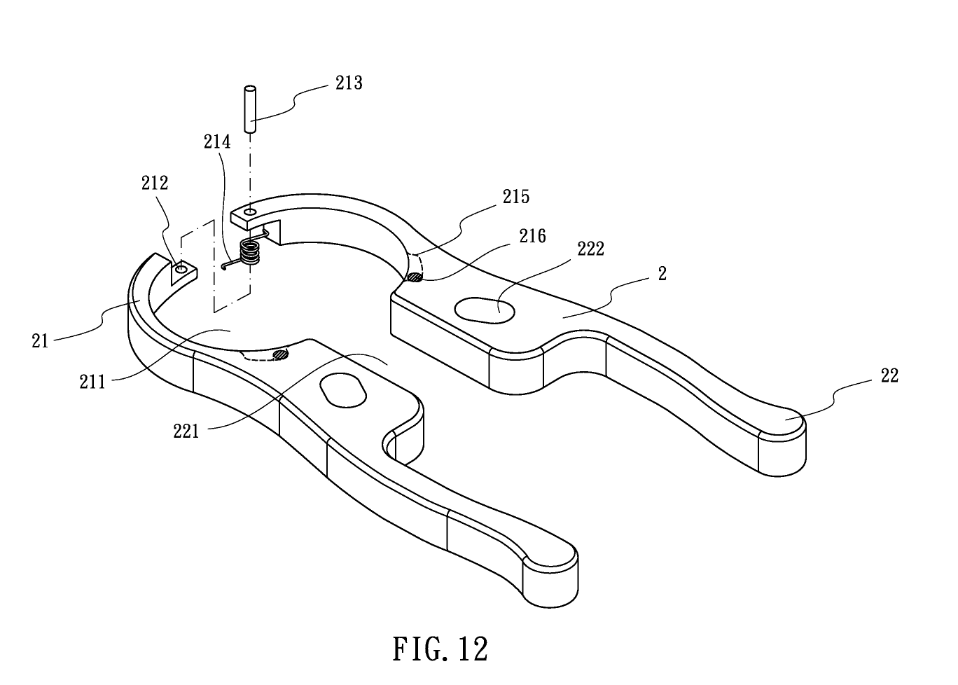

FIG. 12 shows one sub type of the third embodiment of the wrench device in accordance with the present invention. (Only the differences between the main type of the third embodiment and the sub type of the third embodiment are further described). The enclosing portion 21 is formed as two separated pieces. Each separated piece of the enclosing portion 21 has a connecting hole 212 opened at one end thereof. A connecting pin 213 is inserted into each connecting hole 212 of the enclosing portion 21. A torsion spring 214 encloses the connecting pin 213. One end of the torsion spring 214 is abutted against an inner wall of one connecting hole 212 and another end of the torsion spring 214 is abutted against another inner wall of another connecting hole 212. Therefore, the clamp member 2 is flexible.

All in all, the structure of the present invention is simple and the elements used in the present invention is less than the conventional ratchet wrench, therefore, the user can repair or replace the elements in the present invention easily.

Although the invention has been explained in relation to its preferred embodiment, it is to be understood that many other possible modifications and variations can be made without departing from the spirit and scope of the invention as hereinafter claimed.

What is claimed is:

1. A wrench device comprising:
a handle 1, a clamp member 2 and a driving member 3;
the handle 1 having two pivoting holes 11 opened at one end thereof, the clamp member 2 having an enclosing portion 21 defined at one end thereof, the enclosing portion 21 having a enclosing hole 211 opened thereon, the enclosing hole 211 enclosing the driving member 3, the clamp member 2 having two extension portions 22 extended at another end thereof, the two extension portions 22 have a gap 221 defined therebetween, the gap 221 communicating with the enclosing hole 211, each extension portion 22 having an opening 222 defined thereon, the opening 222 of each extension portion 22 corresponding to each corresponding pivoting hole 11 of the handle 1, a pivoting rod 23 being inserted into each opening 222 and each corresponding pivoting hole 11 so as to assemble the clamp member 2 to the handle 1; and
the driving member 3 having an adapting hole 31 opened at a center thereof, the driving member 3 having a fastening groove 32 defined around an outer periphery thereof, the enclosing portion 21 of the clamp member 2 engaged with the fastening groove 32 of the driving member 3 so that the driving member 3 is assembled to the clamp member 2;
wherein when a user wants to lock or unlock the screw, one extension portion 22 is pushed toward one corresponding side of the handle 1 firstly; and then, the handle 1 is rotated in one direction; thereby, one pivoting rod 23 moves to abut against one end of the corresponding opening 222, and another pivoting rod 23 moves to abut against another end of another opening 222; as a result, one pivoting rod 23 pushes one corresponding extension portion 22 toward another extension portion 22, so that the gap 221 is reduced. Therefore, the enclosing portion 21 of the clamp member 2 tightly clamps the fastening groove 32 of the driving member 3 in the enclosing hole 211, so that the driving member 3 is rotated by the rotation of the handle 1 via the clamp member 2. In contrast, when the handle 1 does not be pushed toward one of the two extension portions 22, the gap 221 is recovered. Therefore, the enclosing portion 21 of the clamp member 2 does not clamp the fastening groove 32 of the driving member 3 in the enclosing hole 211; as a result, the user rotates the handle 1 in another direction, and the driving member 3 is not rotated by the enclosing portion 21 of the handle 1.

2. The wrench device as claimed in claim 1, wherein each opening 222 is formed as elliptic; each opening 222 is opened inclinedly relative to the handle 1; the two openings 222 are symmetrical with each other; each opening 222 has a top end and a bottom end; the top end of each opening 222 is adjacent to the enclosing portion 21; a distance between the top ends of the two openings 222 is shorter than another distance between the bottom ends of the two openings 222.

3. The wrench device as claimed in claim 1, wherein the enclosing hole 211 has a plurality of engaging teeth 33′ defined around an inner periphery thereof; the fastening groove 32 has a plurality of fastening teeth 33 defined thereon.

4. The wrench device as claimed in claim 2, wherein the enclosing hole 211 has a plurality of engaging teeth 33′ defined around an inner periphery thereof; the fastening groove 32 has a plurality of fastening teeth 33 defined thereon.

5. The wrench device as claimed in claim 1, wherein the enclosing portion 21 is formed as two separated pieces; each separated piece of the enclosing portion 21 has a connecting hole 212 opened at one end thereof; a connecting pin 213 is inserted into each connecting hole 212 of the enclosing portion 21; a torsion spring 214 encloses the connecting pin 213; one end of the torsion spring 214 is abutted against an inner wall of one connecting hole 212 and another end of the torsion spring 214 is abutted against another inner wall of another connecting hole 212; the clamp member 2 is flexible.

6. The wrench device as claimed in claim 1, wherein the handle 1 has two clipping portions 12 defined at one end thereof; one clipping portion 12 is above another clipping portion 12; the two pivoting holes 11 are both opened from one clipping portion 12 to another clipping portion 12 therethrough; the two clipping portions 12 clips a middle portion of each clamp member 2; each pivoting rod 23 is inserted into the pivoting hole 11 of each clipping portion 12 and the opening 222 of each corresponding extension portion 22.

7. The wrench device as claimed in claim 1, wherein one end of the handle 1 is tilted relative to the whole handle 1; when the user operates the handle 1, the handle 1 will not abut against one of the two extension portions 22 so that the rotation of the handle 1 will not be limited by the extension portions 22.

8. A wrench device comprising:
a handle 1, a clamp member 2 and a driving member 3;
the handle 1 having two pivoting holes 11 opened at one end thereof, the clamp member 2 having an enclosing portion 21 defined at one end thereof, the enclosing portion 21 having a enclosing hole 211 opened thereon, the enclosing hole 211 enclosing the driving member 3, the clamp member 2 having two extension portions 22 extended at another end thereof, the two extension portions 22 have a gap 221 defined therebetween, the gap 221 communicating with the enclosing hole 211, each extension portion 22 having an opening 222 defined thereon, the opening 222 of each extension portion 22 corresponding to each corresponding pivoting hole 11 of the handle 1, a pivoting rod 23 being inserted into each opening 222 and each corresponding pivoting hole 11 so as to assemble the clamp member 2 to the handle 1;
the driving member 3 having an adapting hole 31 opened at a center thereof, the driving member 3 having a fastening groove 32 defined around an outer periphery thereof, the enclosing portion 21 of the clamp member 2 engaged with the fastening groove 32 of the driving member 3 so that the driving member 3 is assembled to the clamp member 2; and
the enclosing hole 211 having two sliding grooves 215 defined on an inner wall thereof, the two sliding grooves 215 respectively located at two sides of the gap 221, one end of each sliding groove 215 adjacent to the gap 221, a depth of each sliding groove 215 gradually decreased from one end thereof to another end thereof, each sliding groove having a rolling unit 216 movably assembled therein; wherein when one rolling unit 216 moves to another end of one sliding groove 215, a contacting area between the driving member 3 and the rolling unit 216 is increased, so that said rolling unit 216 is tightly abutted against the driving member 3; as a result, the driving member 3 is tightly fastened by the enclosing portion 21 and said rolling unit 216;
wherein, when a user wants to lock or unlock the screw, one extension portion 22 is pushed toward one corresponding side of the handle 1 firstly; and then, the handle 1 is rotated in one direction; thereby, one pivoting rod 23 moves to abut against one end of the corresponding opening 222, and another pivoting rod 23 moves to abut against another end of another opening 222; as a result, one pivoting rod 23 pushes one corresponding extension portion 22 toward another extension portion 22, so that the gap 221 is reduced; therefore, the enclosing portion 21 of the clamp member 2 tightly clamps the fastening groove 32 of the driving member 3 in the enclosing hole 211, so that the driving member 3 is rotated by the rotation of the handle 1 via the clamp member 2; in contrast, when the handle 1 does not be pushed toward one of the two extension portions 22, the gap 221 is recovered; as a result, the enclosing portion 21 of the clamp member 2 does not clamp the fastening groove 32 of the driving member 3 in the enclosing hole 211; therefore, the user rotates the handle 1 in another direction, and the driving member 3 is not rotated by the enclosing portion 21 of the handle 1.

9. The wrench device as claimed in claim 8, wherein each opening 222 is formed as elliptic; each opening 222 is opened inclinedly relative to the handle 1; the two openings 222 are symmetrical with each other; each opening 222 has a top end and a bottom end; the top end of each opening 222 is adjacent to the enclosing portion 21; a distance between the top ends of the two openings 222 is shorter than another distance between the bottom ends of the two openings 222.

10. The wrench device as claimed in claim 8, wherein the handle 1 has two clipping portions 12 defined at one end thereof; one clipping portion 12 is above another clipping portion 12; the two pivoting holes 11 are both opened from one clipping portion 12 to another clipping portion 12 therethrough; the two clipping portions 12 clips a middle portion of each clamp member 2; each pivoting rod 23 is inserted into the pivoting hole 11 of each clipping portion 12 and the opening 222 of each corresponding extension portion 22.

11. The wrench device as claimed in claim 9, wherein the handle 1 has two clipping portions 12 defined at one end thereof; one clipping portion 12 is above another clipping portion 12; the two pivoting holes 11 are both opened from one clipping portion 12 to another clipping portion 12 therethrough; the two clipping portions 12 clips a middle portion of each clamp member 2; each pivoting rod 23 is inserted into the pivoting hole 11 of each clipping portion 12 and the opening 222 of each corresponding extension portion 22.

12. The wrench device as claimed in claim 8, wherein the enclosing portion 21 is formed as two separated pieces; each separated piece of the enclosing portion 21 has a connecting hole 212 opened at one end thereof; a connecting pin 213 is inserted into each connecting hole 212 of the enclosing portion 21; a torsion spring 214 encloses the connecting pin 213; one end of the torsion spring 214 is abutted against an inner wall of one connecting hole 212 and another end of the torsion spring 214 is abutted against another inner wall of another connecting hole 212; the clamp member 2 is flexible.

13. The wrench device as claimed in claim 8, wherein one end of the handle 1 is tilted relative to the whole handle 1; when the user operates the handle 1, the handle 1 will not abut against one of the two extension portions 22 so that the rotation of the handle 1 will not be limited by the extension portions 22.
